(19) United States
(12) Patent Application Publication
(10) Pub. No.: US 2023/0069534 A1
(43) Pub. Date: Mar. 2, 2023

(54) PACKET-BASED CALL DETECTION AND PRIORITIZATION

(71) Applicant: RAKUTEN MOBILE, INC., Tokyo (JP)

(72) Inventor: Siddhartha TRIVEDI, Tokyo (JP)

(21) Appl. No.: 17/643,591

(22) Filed: Dec. 9, 2021

Related U.S. Application Data
(60) Provisional application No. 63/239,892, filed on Sep. 1, 2021.

(51) Int. Cl. H04W 28/02; H04W 28/08; H04W 28/24

(52) U.S. Cl. CPC H04W 28/0278; H04W 28/0205; H04W 28/0967; H04W 28/24

(57) ABSTRACT

Packet-based call detection and prioritization is performed by receiving an instruction to detect and prioritize packet-based call transmissions from a radio access network, detecting, in response to receiving the instruction, a packet-based call transmission through a default bearer of the radio access network based on a buffer state report from at least one of a terminal among a plurality of terminals and an access point of the radio access network, and prioritizing a subsequent transmission of the packet-based call transmission.

### PRIORITY CLAIM AND CROSS-REFERENCE

This application claims priority to Provisional Application No. 63/239,892, filed Sep. 1, 2021, which is hereby incorporated by reference in its entirety.

### BACKGROUND

In response to certain events, such as natural disasters like earthquakes or tsunamis, or special events like midnight of the New Year, telecommunications networks often experience a surge in voice and video traffic. Voice-over-Long-Term-Evolution (VoLTE) and Video-over-LTE (ViLTE) traffic using the services of the provider are transmitted through a dedicated bearer with a set of Quality-of-Service (QoS) parameters to prioritize and maintain the connections of such traffic. VoLTE and ViLTE traffic using third-party services, such as SKYPE®, WHATSAPP®, VIBER®, LINE®, and other Over-the-Top (OTT) voice applications, are transmitted through a default bearer along with all other traffic, such as general web-browsing, video streaming, live gaming, etc.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a system for emergency broadcast instruction response, according to at least one embodiment of the present invention.

FIG. 2 is an operational flow for packet-based call detection and prioritization, according to at least one embodiment of the present invention.

FIG. 3 is an operational flow for packet-based call detection, according to at least one embodiment of the present invention.

FIG. 4 is an operational flow for packet-based call prioritization, according to at least one embodiment of the present invention.

FIG. 5 is a further operational flow for packet-based call prioritization, according to at least one embodiment of the present invention.

FIG. 6 is a schematic diagram of an apparatus for packet-based call detection and prioritization, according to at least one embodiment of the present invention.

FIG. 7 is a block diagram of an exemplary hardware configuration for packet-based call detection and prioritization, according to at least one embodiment of the present invention.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. In addition, the present disclosure may repeat reference numerals and/or letters in the various examples. This repetition is for the purpose of simplicity and clarity and does not in itself dictate a relationship between the various embodiments and/or configurations discussed.

Many telecommunications providers do not prioritize VoLTE and ViLTE traffic using third-party services because quality of such traffic is the responsibility of a different party. Therefore, such traffic is transmitted through the same bearer as all other traffic, which often leads to sub-optimal voice and video quality, especially in cases of certain events. For example, user traffic naturally increases in response to receiving “WriteReplaceWarningRequest” (WRWR) alerts for sharing information and updating current status. OTT based applications use the default dearer, such as the QoS Class Identifier (QCI) 9 bearer in LTE, even to carry voice and video call traffic. Therefore, users cannot expect quality assurance over the radio access network for such voice and video call traffic because the default bearer is supporting all other general traffic in the same pipeline.

At least some embodiments described herein relate to third-party application based voice and video traffic prioritization for radio access networks in the event of an Earthquake and Tsunami Warning System (ETWS) transmission or a Public Warning System (PWS) event. In at least some embodiments, third-party application based voice and video traffic is detected from buffer state reports having continuous grants of GPRS Tunneling Protocol (GTP) sessions over the GTP user plane (GTP-U), and prioritized from core network driven QCI prioritization for the end-to-end transmission or Internet Protocol (IP) Traffic filtering. In at least some embodiments, a situation-based traffic model changes in the case of a special event.

In at least some embodiments, the event of a PWS warning triggers a telecommunications network to broadcast WRWR or intimation messages to a targeted area so that terminals of end users will receive an alert. In at least some embodiments, when the “WRWR message” is received from the core network and pushed to Radio Network Protocol stack L3/L2/L1 layers to broadcast the PWS, an apparatus according to at least some embodiments will start to analyze Medium Access Control (MAC) layer Buffer State Reports (BSR) of individual terminals for information of the terminal downlink grant request of the Packet Data Convergence Protocol (PDCP) layer and the GTP traffic packet size, and/or BSRs of core driven individual IP packets streaming over a user plane, in order to detect video and voice call traffic based on packet size grant continuity. In at least some embodiments, detected video and voice call traffic are prioritized and allocated grants using an artificial traffic priority of a portion of total default bearer bandwidth. In at least some embodiments, such prioritization and allocation is time or traffic model specific, and reverts the prioritization and allocation to the previous state upon expiration of time or other terminal condition.

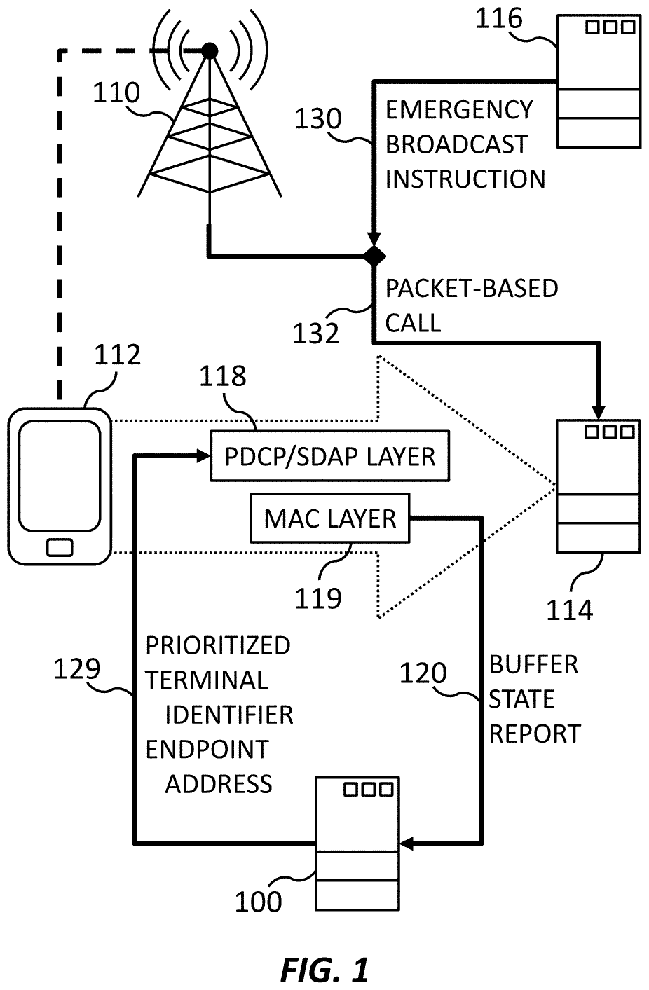

FIG. 1 is a schematic diagram of a system for emergency broadcast instruction response, according to at least one embodiment of the present invention. The diagram includes an apparatus 100, a radio access network 110, a terminal 112, an endpoint server 114, and an emergency broadcast server 116.

Emergency broadcast server 116 is configured to transmit an emergency broadcast instruction 130 to radio access network 110. In at least some embodiments, emergency broadcast server 116 is a PWS or ETWS server. In at least some embodiments, emergency broadcast server 116 is configured to transmit a WRWR alert instruction. In at least some embodiments, emergency broadcast server 116 is configured to transmit emergency broadcast instruction 130 in response to a natural disaster, such as an earthquake or tsunami.

Radio access network 110 is configured to provide communication services to terminals, connecting terminals, such as terminal 112, to other terminals and to devices, such as endpoint server 114, connected through other networks, such as the Internet. In at least some embodiments, radio access network 110 includes access points or nodes configured to connect directly to terminals and servers configured to route connections between terminals and other devices and servers through the radio access network and other networks, such as the Internet. In at least some embodiments, radio access network 110 includes one or more Mobility Management Entities (MME) or Access and Mobility management Functions (AMF, one or more Cell Broadcast Entities (CBE). In at least some embodiments, radio access network 110 is configured to operate according to the 3GPP standard of E-UTRAN. In at least some embodiments, radio access network 110 is configured to transmit communication through multiple layers, such as a PDCP/SDAP layer 118 and a MAC layer 119. In at least some embodiments, radio access network 110 is configured to transmit unprivileged communication through a default bearer.

Radio access network 110 is configured to receive emergency broadcast instruction 130 from emergency broadcast server 116. In at least some embodiments, radio access network 110 is configured to receive emergency broadcast instruction 130 through a CBE and an MME or AMF. In at least some embodiments, radio access network 110 is configured to broadcast paging messages, such as System Information Block (SIB) messages to connected terminals in response to receiving emergency broadcast instruction 130.

In at least some embodiments, radio access network 110 is configured to instruct apparatus 100 to perform packet-based call detection and prioritization in response to receiving emergency broadcast instruction 130. In at least some embodiments, radio access network 110 is configured to instruct apparatus 100 to perform packet-based call detection and prioritization in response to a sudden increase in traffic. In at least some embodiments, radio access network 110 is configured to instruct apparatus 100 to perform packet-based call detection and prioritization at times of expected sudden increases in traffic, such as midnight of a New Year. In at least some embodiments, radio access network 110 is configured to schedule additional grants for packet-based call transmissions.

Terminal 112 is configured to communicate with other terminals and devices through radio access network 110. In at least some embodiments, terminal 112 is configured to communicate with another terminal through endpoint server 114. In at least some embodiments, terminal 112 includes an application configured to establish a packet-based call, such as pack-based voice call 132, with another terminal through endpoint server 114.

Endpoint server 114 is configured to communicate through at least radio access network 110. In at least some embodiments, endpoint server 114 is configured to map connection paths between terminals communicating through radio access network 110, such as terminal 112, to establish packet-based calls. In at least some embodiments, endpoint server 114 provides packet-based call service facilitated by an application executed on each terminal, such as terminal 112.

Apparatus 100 is configured to perform packet-based call detection and prioritization. In at least some embodiments, apparatus 100 is configured to perform packet-based call detection and prioritization in response to an instruction from radio access network 110. In at least some embodiments, apparatus 100 is configured to receive MAC layer buffer state reports, such as buffer state report 120 from radio access network 110, and to transmit terminal identifiers and endpoint addresses determined to be prioritized, such as prioritized terminal identifier and endpoint address 129. In at least some embodiments, apparatus 100 is configured to detect packet-based call transmissions from the buffer state reports. In at least some embodiments, apparatus 100 is configured to determine whether a packet size and a grant continuity represented in the state report indicates a packet-based call transmission. In at least some embodiments, apparatus 100 is configured to apply a model to the information in each buffer state report to determine whether the buffer state report indicates a packet-based call transmission. In at least some embodiments, apparatus 100 is an Operational Support System (OSS) or an Operation Administration and Maintenance (OAM) server. In at least some embodiments, apparatus 100 is configured to detect packet-based call services from the buffer state reports.

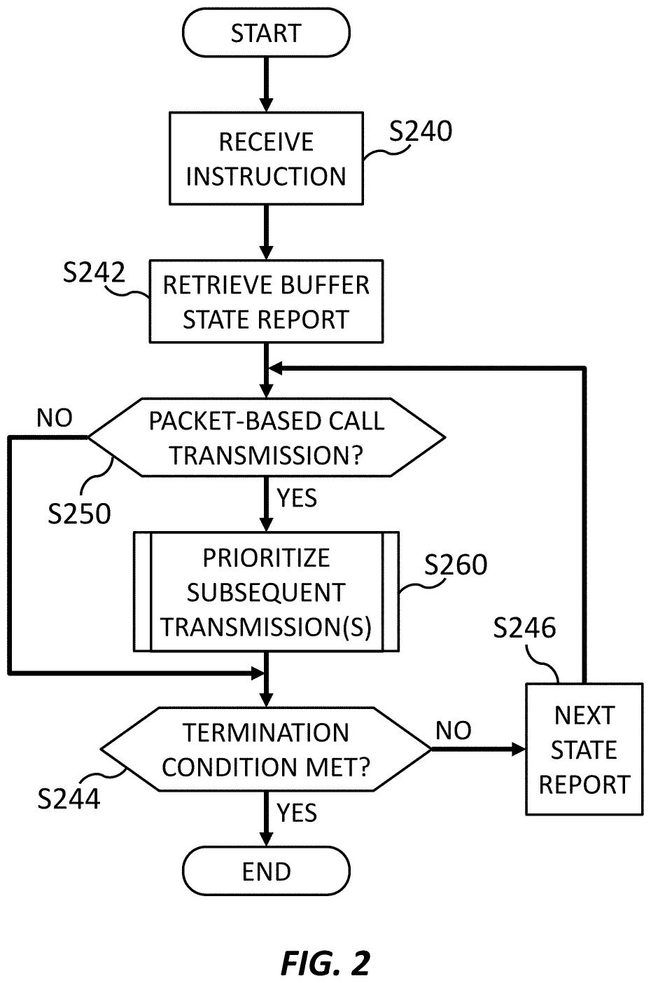

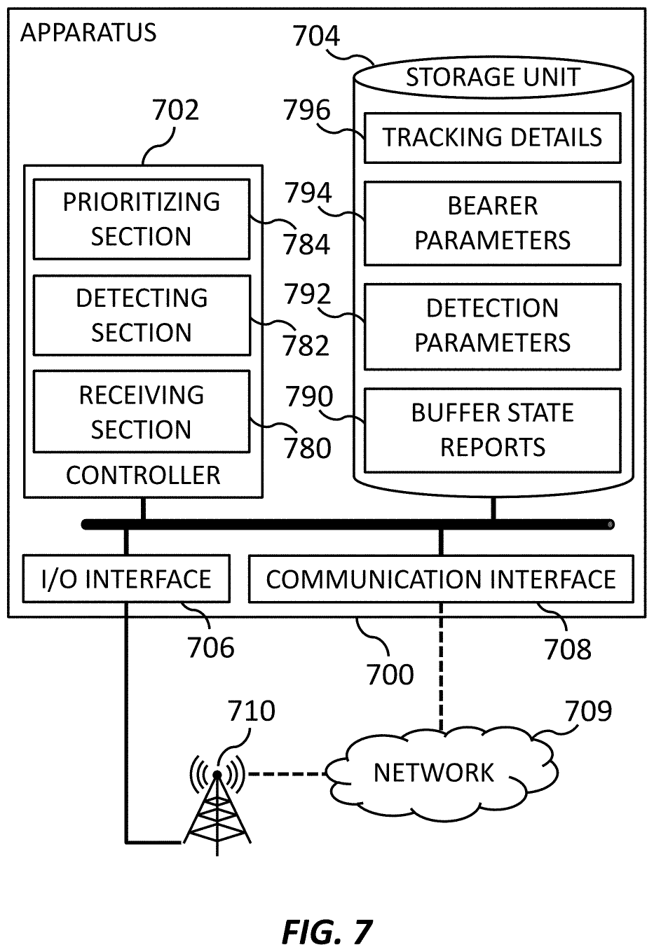

FIG. 2 is an operational flow for packet-based call detection and prioritization, according to at least one embodiment of the present invention. The operational flow provides a method of packet-based call detection and prioritization. In at least some embodiments, the method is performed by a controller of an apparatus including sections for performing certain operations, such as the controller and apparatus shown in FIG. 7, which will be explained hereinafter.

At S240, a receiving section or a sub-section thereof receives an instruction to perform packet-based call detection and prioritization. In at least some embodiments, the receiving section receives an instruction to detect and prioritize packet-based call transmissions from a radio access network. In at least some embodiments, the receiving section receives an instruction to perform packet-based call detection and prioritization for a predetermined time period or until a condition is met. In at least some embodiments, the receiving section receives an instruction from an emergency broadcast server.

At S242, a receiving section or a sub-section thereof retrieves a buffer state report. In at least some embodiments, the receiving section retrieves one or more buffer state reports from a MAC layer protocol of the radio access network. In at least some embodiments, the receiving section retrieves buffer state reports as they are transmitted from terminals connected to the radio access network or from access points of the radio access network. In at least some embodiments, the receiving section retrieves buffer state reports from a temporary storage in the radio access network.

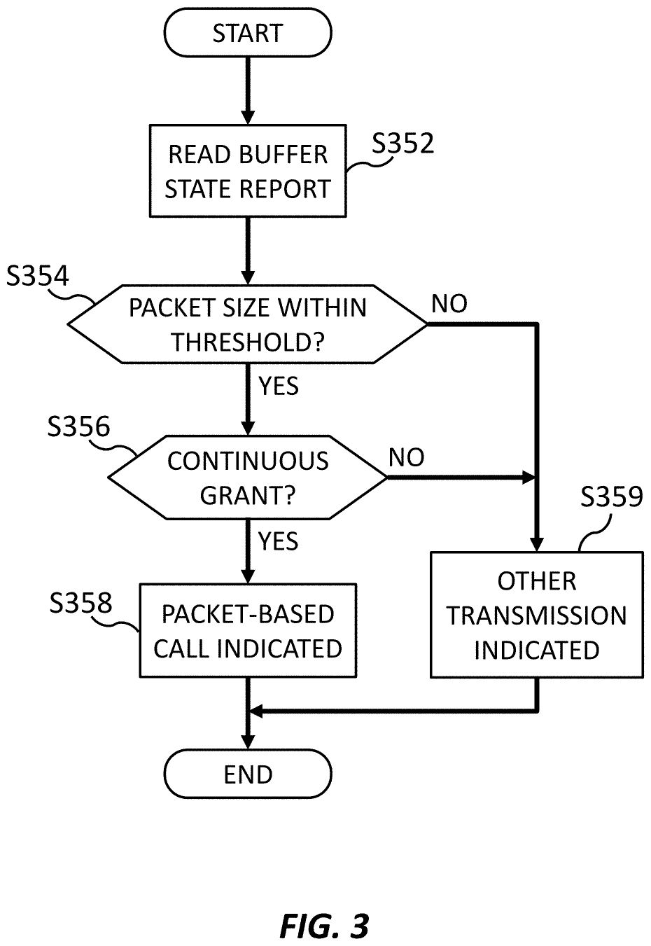

At S250, a detecting section or a sub-section thereof detects a packet-based call transmission from the buffer state report retrieved at S242. In at least some embodiments, the detecting section detects, in response to receiving the instruction, a packet-based call transmission through a default bearer of the radio access network based on a buffer state report from at least one of a terminal among a plurality of terminals and an access point of the radio access network. In at least some embodiments, the detecting section determines whether a packet size and a grant continuity represented in the buffer state report indicates a packet-based call transmission. In at least some embodiments, the detecting section applies a model to the information in each buffer state report to determine whether the buffer state report indicates a packet-based call transmission. If the detecting section detects a packet-based call transmission, then the operational flow proceeds to prioritization at S260. If the detecting section does not detect a packet-based call transmission, then the operational flow proceeds to S244, at which a termination condition is checked. In at least some embodiments, the detecting proceeds as shown in FIG. 3, which will be explained hereinafter.

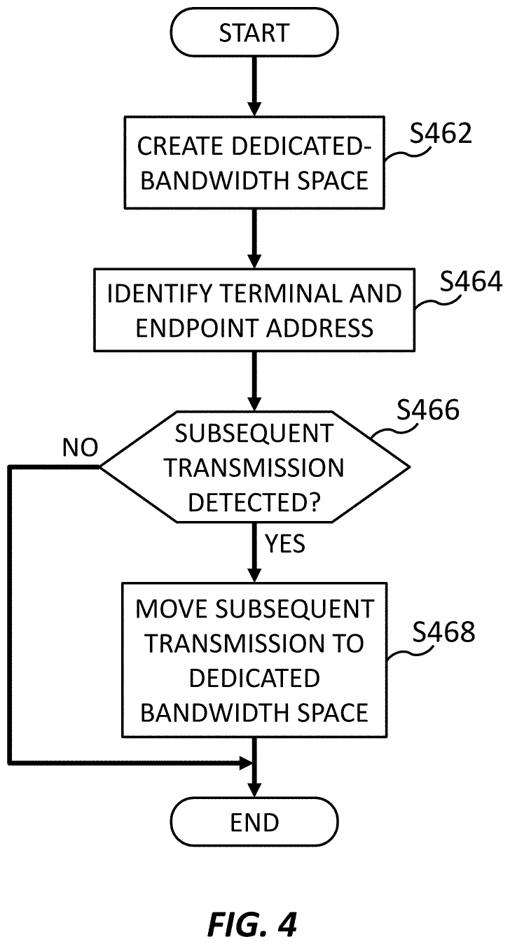

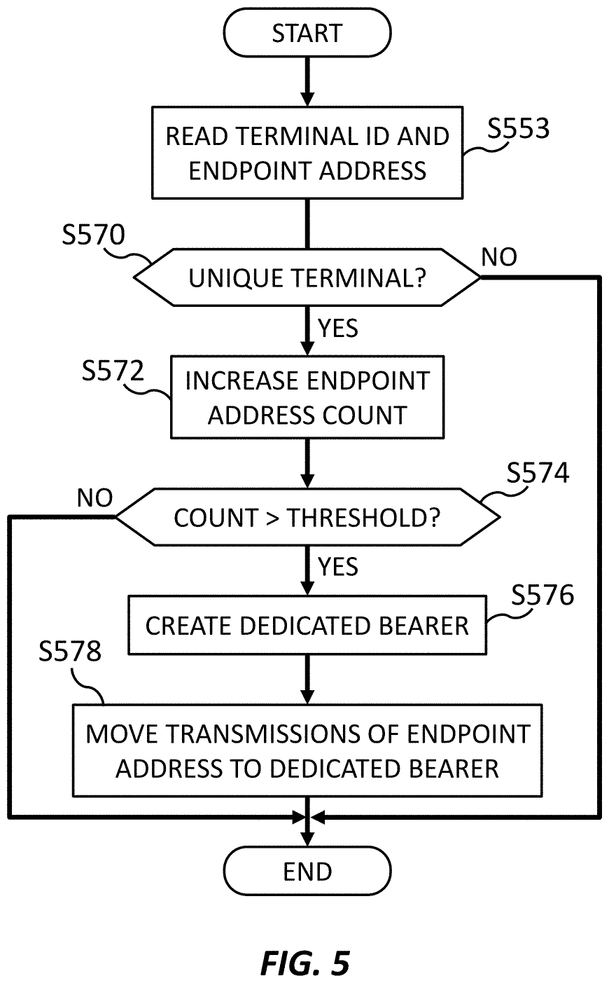

At S260, a prioritizing section or a sub-section thereof prioritizes subsequent transmissions of a packet-based call transmission detected at S250. In at least some embodiments, the prioritizing section notifies the radio access network that a packet-based call transmission has been detected, and provides the radio access network with information to identify subsequent transmissions. In at least some embodiments, the prioritizing proceeds as shown in FIG. 4 or as shown in FIG. 5, which will be explained hereinafter.

At S244, the controller or a section thereof determines whether a termination condition has been met. In at least some embodiments, the controller determines whether a predetermined time period has elapsed, or whether communication traffic has been reduced below a threshold amount. If the controller determines that the termination condition has not been met, then the operational flow proceeds to S246 to retrieve the next buffer state report before returning to detection at S250. If the controller determines that the termination condition has been met, then the operational flow ends.

FIG. 3 is an operational flow for packet-based call detection, according to at least one embodiment of the present invention. The operational flow provides a method of packet-based call detection. In at least some embodiments, the method is performed by a detecting section of an apparatus, such as the detecting section shown in FIG. 7, which will be explained hereinafter.

At S352, the detecting section or a sub-section thereof reads a buffer state report. In at least some embodiments, the detecting section reads a packet size and a grant continuity represented in the buffer state report. In at least some embodiments, the detecting section reads, from the buffer state report, a terminal identifier and an endpoint address receiving the packet-based call transmission.

At S354, the detecting section or a sub-section thereof determines whether the packet size is less than a threshold size. In at least some embodiments, the threshold size is 1500 kB. In at least some embodiments, the threshold size is predetermined based on historical data. In at least some embodiments, the threshold size is determined by a model trained with buffer state report information. If the detecting section determines that the packet size is less than a threshold size, then the operational flow proceeds to continuous grant determination at S356. If the detecting section determines that the packet size is less than a threshold size, then the operational flow proceeds to S359, at which the detecting section concludes that another type of transmission is indicated in the buffer state report.

At S356, the detecting section or a sub-section thereof determines whether the grant continuity is continuous. In at least some embodiments, the grant continuity is read directly from the buffer state report. In at least some embodiments, the grant continuity is observed across multiple buffer state reports from the same terminal. If the detecting section determines that the grant continuity is continuous, then the operational flow proceeds to S358, at which the detecting section concludes that a packet-based call transmission is indicated in the buffer state report. If the detecting section determines that grant continuity is not continuous, then the operational flow proceeds to S359, at which the detecting section concludes that another type of transmission is indicated in the buffer state report.

FIG. 4 is an operational flow for packet-based call prioritization, according to at least one embodiment of the present invention. The operational flow provides a method of packet-based call prioritization. In at least some embodiments, the method is performed by a prioritizing section of an apparatus, such as the prioritizing section shown in FIG. 7, which will be explained hereinafter.

At S462, the prioritizing section or a sub-section thereof creates dedicated-bandwidth space within a default bearer of a radio access network for packet-based call transmissions. In at least some embodiments, the prioritizing section causes a radio access network or a server therein to create dedicated-bandwidth space in the default bearer. In at least some embodiments, the prioritizing section partitions bandwidth of the default bearer to create a dedicated-bandwidth space within the default bearer. In at least some embodiments, the portion of the default bearer dedicated to packet-based call transmissions is 50%. In at least some embodiments, the portion of the default bearer dedicated to packet-based call transmissions is predetermined based on a triggering event.

At S464, the prioritizing section or a sub-section thereof identifies the terminal and endpoint address of a buffer state report determined to indicate a packet-based call transmission. In at least some embodiments, the prioritizing section identifies, from the buffer state report, a terminal identifier and an endpoint address receiving the packet-based call transmission. In at least some embodiments, the prioritizing section refers to the terminal identifier and endpoint address read by the detecting section, such as at S352 shown in FIG. 3.

At S466, the prioritizing section or a sub-section thereof detects a subsequent transmission of the packet-based call transmission detected in the buffer state report. In at least some embodiments, the prioritizing section causes the detecting section to detect the subsequent transmission. In at least some embodiments, the prioritizing section identifies the subsequent transmission by the terminal identifier and the endpoint address. In at least some embodiments, the prioritizing section detects transmissions of the same terminal and endpoint address from buffer state reports. If the prioritizing section detects a subsequent transmission, then the operational flow proceeds to subsequent transmission movement at S468. If the prioritizing section does not detect a subsequent transmission, then the operational flow ends.

At S468, the prioritizing section or a sub-section thereof moves the subsequent transmission detected at S466 to the dedicated-bandwidth space within the default bearer. In at least some embodiments, the prioritizing section moves the subsequent transmission of the packet-based call transmission to the dedicated-bandwidth space. In at least some embodiments, the prioritizing section causes a radio access network or a server therein to move the subsequent transmission to the dedicated-bandwidth space within the default bearer. In at least some embodiments, the packet-based call transmissions are moved to the dedicated-bandwidth space within the default bearer, while transmissions that are not detected as packet-based call transmissions, such as general web-browsing, video streaming, live gaming, etc., remain in the remaining space of the default bearer. In at least some embodiments, the prioritizing section notifies the radio access network of the terminal identifier and endpoint address of the buffer state report determined to indicate a packet-based call transmission. In at least some embodiments, the prioritizing section instructs the radio access network to schedule additional grants for transmissions between the terminal identifier and endpoint address of the buffer state report determined to indicate a packet-based call transmission.

FIG. 5 is a further operational flow for packet-based call prioritization, according to at least one embodiment of the present invention. The operational flow provides a further method of packet-based call prioritization. In at least some embodiments, the method is performed by a prioritizing section of an apparatus, such as the prioritizing section shown in FIG. 7, which will be explained hereinafter.

At S553, the prioritizing section or a sub-section thereof reads a terminal identifier and an endpoint address from a buffer state report. In at least some embodiments, the prioritizing section reads, from the buffer state report, the terminal identifier and the endpoint address receiving the packet-based call transmission. In at least some embodiments, the prioritizing section refers to the terminal identifier and endpoint address read by the detecting section, such as at S352 shown in FIG. 3.

At S570, the prioritizing section or a sub-section thereof determines whether the terminal identifier read from the buffer state report is unique with respect to the endpoint address. In at least some embodiments, the prioritizing section compares the terminal identifier with previously identified terminal identifiers read from past buffer state reports including the endpoint address and determined to indicate a packet-based call transmission. In at least some embodiments, if the terminal identifier has not appeared for a predetermined amount of time, then the prioritizing section considers the terminal identifier to be unique because the call is likely separate from the previous appearance. If the prioritizing section determines that the terminal identifier is unique with respect to the endpoint address, then the operational flow proceeds to S572, at which a count for the corresponding endpoint address is increased. If the prioritizing section determines that the terminal identifier is not unique with respect to the endpoint address, then the operational flow ends.

At S574, the prioritizing section or a sub-section thereof determines whether the count for the corresponding endpoint address has exceeded a threshold count. In at least some embodiments, the prioritizing section determines whether the end point address provides packet-based call service based on a number of unique terminals performing packet-based call transmissions to the endpoint address. If the prioritizing section determines that the count has exceeded the threshold count, then the prioritizing section determines that the end point address provides packet-based call service, and the operational flow proceeds to dedicated bearer creation at S576. If the prioritizing section determines that the count has not exceeded the threshold count, then the prioritizing section determines that the end point address does not provide packet-based call service, and the operational flow ends. Examples of packet-based call services include services provided by SKYPE®, WHATSAPP®, VIBER®, LINE®, and other Over-the-Top (OTT) voice applications.

At S576, the prioritizing section or a sub-section thereof creates a dedicated bearer for the endpoint address determined to provide packet-based call service. In at least some embodiments, the prioritizing section creates a dedicated bearer for the end point address in response to determining that the end point address provides packet-based call service. In at least some embodiments, the prioritizing section causes a radio access network or a server therein to create the dedicated bearer for the endpoint address determined to provide packet-based call service.

At S578, the prioritizing section or a sub-section thereof moves transmissions of the endpoint address to the dedicated bearer. In at least some embodiments, the prioritizing section moves transmissions of the end point address to the dedicated bearer. In at least some embodiments, the prioritizing section causes a radio access network or a server therein to move transmissions of the endpoint address to the dedicated bearer. In at least some embodiments, the packet-based call transmissions are moved to the dedicated bearer, while transmissions that are not detected as packet-based call transmissions, such as general web-browsing, video streaming, live gaming, etc., remain in the default bearer. In at least some embodiments, the prioritizing section notifies the radio access network of the endpoint address determined to provide packet-based call service. In at least some embodiments, the prioritizing section prepares a configuration package to all relevant access points, and updates the end-to-end QoS profile across the access points.

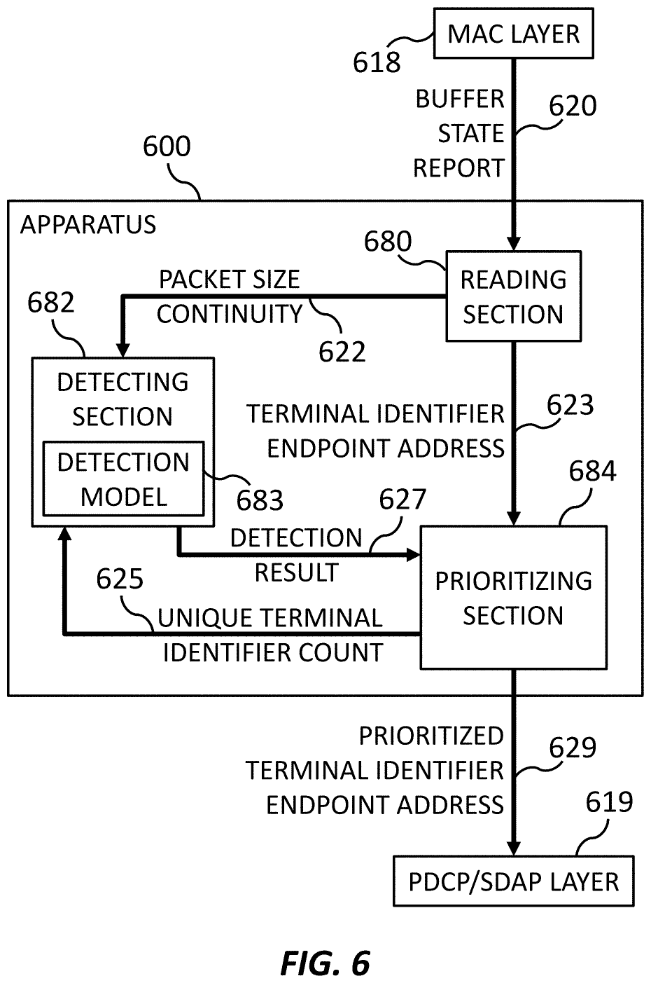

FIG. 6 is a schematic diagram of an apparatus for packet-based call detection and prioritization, according to at least one embodiment of the present invention. The diagram includes an apparatus 600, a MAC layer 618, and a PDCP/SDAP layer 619.

Apparatus 600 is in communication with MAC layer 618 and PDCP/SDAP layer 619. In at least some embodiments, apparatus 600 is configured to receive buffers state reports, such as buffer state report 620, from MAC layer 618, to detect packet-based call transmissions from the buffer state reports, and to transmit terminal identifiers and endpoint addresses of buffer state reports determined to indicate a packet-based call transmission to PDCP/SDAP layer 619 in order to prioritize packet-based call transmissions.

Apparatus 600 includes a reading section 680, a detecting section 682, and a prioritizing section 684. In at least some embodiments, reading section 680 is configured to read buffer state reports, such as buffer state report 620, to transmit a packet size and a grant continuity, such as packet size and grant continuity 622, to detection model 682, and to transmit a terminal identifier and an endpoint address, terminal identifier and endpoint address 623, to prioritizing section 684. In at least some embodiments, detecting section 682 is configured to applying a model to the packet size and the grant continuity. In at least some embodiments, detecting section 682 is configured to apply a detection model 682 to the packet size and grant continuity of buffer state reports, and to transmit an output of detection model 682 of whether the buffer state report indicates a packet-based call transmission, such as detection result 627, to prioritizing section 684. In at least some embodiments, prioritizing section 684 is configured to receive results from detecting section 682, such as detection result 627, and to prioritize subsequent transmissions of a packet-based call transmission by providing PDCP/SDAP layer 619 of the radio access network with information to identify subsequent transmissions, such as prioritized terminal identifier and endpoint address 629.

In at least some embodiments, prioritizing section 684 is configured to track terminal identifiers of buffer state reports in order to maintain a count of unique terminal identifiers for each endpoint address. In at least some embodiments, prioritizing section 684 is further configured to determine whether the end point address provides packet-based call service based on a number of unique terminals performing packet-based call transmissions to the endpoint address. In at least some embodiments, prioritizing section 684 is configured to transmit a unique terminal identifier count to detecting section 682. In at least some embodiments, detecting section 682 is configured to further applying the model to a number of unique terminals performing packet-based call transmissions to the endpoint address. In at least some embodiments, detecting section 682 is configured to further apply detection model 682 to the unique terminal identifier count corresponding to the endpoint address of the buffer state report, such as unique terminal identifier count 625.

FIG. 7 is a block diagram of an exemplary hardware configuration for packet-based call detection and prioritization, according to at least one embodiment of the present invention.

The exemplary hardware configuration includes apparatus 700, which communicates with network 709, and interacts with radio access network 710. In at least some embodiments, apparatus 700 is a computer or other computing device that receives input or commands from radio access network 710. In at least some embodiments, apparatus 700 is a host server that connects directly to radio access network 710, or indirectly through network 709. In at least some embodiments, apparatus 700 is a computer system that includes two or more computers. In at least some embodiments, apparatus 700 is a personal computer that executes an application for a user of apparatus 700.

Apparatus 700 includes a controller 702, a storage unit 704, a communication interface 708, and an input/output interface 706. In at least some embodiments, controller 702 includes a processor or programmable circuitry executing instructions to cause the processor or programmable circuitry to perform operations according to the instructions. In at least some embodiments, controller 702 includes analog or digital programmable circuitry, or any combination thereof. In at least some embodiments, controller 702 includes physically separated storage or circuitry that interacts through communication. In at least some embodiments, storage unit 704 includes a non-volatile computer-readable medium capable of storing executable and non-executable data for access by controller 702 during execution of the instructions. Communication interface 708 transmits and receives data from network 709. Input/output interface 706 connects to various input and output units via a parallel port, a serial port, a keyboard port, a mouse port, a monitor port, and the like to accept commands and present information.

Controller 702 includes receiving section 780, detecting section 782, and prioritizing section 784. Storage unit 704 includes buffer state reports 790, detection parameters 792, bearer parameters 794, and tracking details 796.

Receiving section 780 is the circuitry or instructions of controller 702 configured to receive instructions to perform packet-based call detection and prioritization, and to retrieve buffer state reports. In at least some embodiments, receiving section 780 is configured to read information from buffer state reports, such as packet size, grant continuity, terminal identifier, and endpoint address. In at least some embodiments, receiving section 780 records information to storage unit 704, such as in buffer state reports 790. In at least some embodiments, receiving section 780 includes sub-sections for performing additional functions, as described in the foregoing flow charts. In at least some embodiments, such sub-sections may be referred to by a name associated with their function.

Detecting section 782 is the circuitry or instructions of controller 702 configured to detect packet-based call transmissions from the buffer state reports. In at least some embodiments, detecting section 782 is configured to detect, in response to receiving an instruction, packet-based call transmissions through a default bearer of the radio access network based on buffer state reports from terminals and access points of the radio access network. In at least some embodiments, detecting section 782 utilizes information in storage unit 704, such as buffer state reports 790 and detection parameters 792. In at least some embodiments, detecting section 782 includes sub-sections for performing additional functions, as described in the foregoing flow charts. In at least some embodiments, such sub-sections may be referred to by a name associated with their function.

Prioritizing section 784 is the circuitry or instructions of controller 702 configured to prioritize subsequent transmissions of detected packet-based call transmissions. In at least some embodiments, prioritizing section 784 is configured to notify the radio access network that a packet-based call transmission has been detected or that a packet-based call service has been detected. In at least some embodiments, prioritizing section 784 utilizes information in storage unit 704, such as bearer parameters 794, and records information to storage unit 704, such as in tracking details 796. In at least some embodiments, prioritizing section 784 includes sub-sections for performing additional functions, as described in the foregoing flow charts. In at least some embodiments, such sub-sections may be referred to by a name associated with their function.

In at least some embodiments, the apparatus is another device capable of processing logical functions in order to perform the operations herein. In at least some embodiments, the controller and the storage unit need not be entirely separate devices, but share circuitry or one or more computer-readable mediums in some embodiments. In at least some embodiments, the storage unit includes a hard drive storing both the computer-executable instructions and the data accessed by the controller, and the controller includes a combination of a central processing unit (CPU) and RAM, in which the computer-executable instructions are able to be copied in whole or in part for execution by the CPU during performance of the operations herein.

In at least some embodiments where the apparatus is a computer, a program that is installed in the computer is capable of causing the computer to function as or perform operations associated with apparatuses of the embodiments described herein. In at least some embodiments, such a program is executable by a processor to cause the computer to perform certain operations associated with some or all of the blocks of flowcharts and block diagrams described herein.

Various embodiments of the present invention are described with reference to flowcharts and block diagrams whose blocks may represent (1) steps of processes in which operations are performed or (2) sections of a controller responsible for performing operations. Certain steps and sections are implemented by dedicated circuitry, programmable circuitry supplied with computer-readable instructions stored on computer-readable media, and/or processors supplied with computer-readable instructions stored on computer-readable media. In some embodiments, dedicated circuitry includes digital and/or analog hardware circuits and may include integrated circuits (IC) and/or discrete circuits. In some embodiments, programmable circuitry includes reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

Various embodiments of the present invention include a system, a method, and/or a computer program product. In some embodiments, the computer program product includes a computer readable storage medium (or media) having computer readable program instructions thereon for causing a processor to carry out aspects of the present invention.

In some embodiments, the computer readable storage medium includes a tangible device that is able to retain and store instructions for use by an instruction execution device. In some embodiments, the computer readable storage medium includes, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, computer readable program instructions described herein are downloadable to respective computing/processing devices from a computer readable storage medium or to an external computer or external storage device via a network, for example, the Internet, a local area network, a wide area network and/or a wireless network. In some embodiments, the network may includes copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

In some embodiments, computer readable program instructions for carrying out operations described above are assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In some embodiments, the computer readable program instructions are executed entirely on the user's computer, partly on the user's computer, as a stand-alone software package, partly on the user's computer and partly on a remote computer or entirely on the remote computer or server. In some embodiments, in the latter scenario, the remote computer is connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) execute the computer readable program instructions by utilizing state information of the computer readable program instructions to individualize the electronic circuitry, in order to perform aspects of the present invention.

While embodiments of the present invention have been described, the technical scope of any subject matter claimed is not limited to the above described embodiments. It will be apparent to persons skilled in the art that various alterations and improvements can be added to the above-described embodiments. It will also be apparent from the scope of the claims that the embodiments added with such alterations or improvements are included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the processes must be performed in this order.

According to at least one embodiment of the present invention, packet-based call detection and prioritization is performed by receiving an instruction to detect and prioritize packet-based call transmissions from a radio access network, detecting, in response to receiving the instruction, a packet-based call transmission through a default bearer of the radio access network based on a buffer state report from at least one of a terminal among a plurality of terminals and an access point of the radio access network, and prioritizing a subsequent transmission of the packet-based call transmission.

Some embodiments include the instructions in a computer program, the method performed by the processor executing the instructions of the computer program, and an apparatus that performs the method. In some embodiments, the apparatus includes a controller including circuitry configured to perform the operations in the instructions.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A computer-readable medium including instructions executable by a computer to cause the computer to perform operations comprising:
receiving an instruction to detect and prioritize packet-based call transmissions from a radio access network;
detecting, in response to receiving the instruction, a packet-based call transmission through a default bearer of the radio access network based on a buffer state report from at least one of a terminal among a plurality of terminals and an access point of the radio access network; and
prioritizing a subsequent transmission of the packet-based call transmission.

2. The computer-readable medium of claim 1, wherein the prioritizing includes
partitioning bandwidth of the default bearer to create a dedicated-bandwidth space within the default bearer, and
moving the subsequent transmission of the packet-based call transmission to the dedicated-bandwidth space.

3. The computer-readable medium of claim 1, wherein the detecting includes determining whether a packet size and a grant continuity represented in the buffer state report indicates a packet-based call transmission.

4. The computer-readable medium of claim 3, wherein the detecting further includes determining whether the packet size is less than a threshold size and the grant continuity is continuous.

5. The computer-readable medium of claim 3, wherein the determining includes applying a model to the packet size and the grant continuity.

6. The computer-readable medium of claim 5, wherein the determining includes further applying the model to a number of unique terminals performing packet-based call transmissions to the endpoint address.

7. The computer-readable medium of claim 1, further comprising determining whether the end point address provides packet-based call service based on a number of unique terminals performing packet-based call transmissions to the endpoint address.

8. The computer-readable medium of claim 7, wherein the prioritizing includes
creating a dedicated bearer for the end point address in response to determining that the end point address provides packet-based call service, and
moving transmissions of the end point address to the dedicated bearer.

9. The computer-readable medium of claim 1,
wherein the detecting includes reading, from the buffer state report, a terminal identifier and an endpoint address receiving the packet-based call transmission; and
wherein the prioritizing includes identifying the subsequent transmission by the terminal identifier and the endpoint address.

10. A method comprising:
receiving an instruction to detect and prioritize packet-based call transmissions from a radio access network;
detecting, in response to receiving the instruction, a packet-based call transmission through a default bearer of the radio access network based on a buffer state report from at least one of a terminal among a plurality of terminals and an access point of the radio access network; and
prioritizing a subsequent transmission of the packet-based call transmission.

11. The method of claim 10, wherein the prioritizing includes
partitioning bandwidth of the default bearer to create a dedicated-bandwidth space within the default bearer, and
moving the subsequent transmission of the packet-based call transmission to the dedicated-bandwidth space.

12. The method of claim 10, wherein the detecting includes determining whether a packet size and a grant continuity represented in the buffer state report indicates a packet-based call transmission.

13. The method of claim 12, wherein the detecting further includes determining whether the packet size is less than a threshold size and the grant continuity is continuous.

14. The method of claim 12, wherein the determining includes applying a model to the packet size and the grant continuity.

15. The method of claim 14, wherein the determining includes further applying the model to a number of unique terminals performing packet-based call transmissions to the endpoint address.

16. The method of claim 10, further comprising determining whether the end point address provides packet-based call service based on a number of unique terminals performing packet-based call transmissions to the endpoint address.

17. The method of claim 16, wherein the prioritizing includes
creating a dedicated bearer for the end point address in response to determining that the end point address provides packet-based call service, and
moving transmissions of the end point address to the dedicated bearer.

18. The method of claim 10,
wherein the detecting includes reading, from the buffer state report, a terminal identifier and an endpoint address receiving the packet-based call transmission; and
wherein the prioritizing includes identifying the subsequent transmission by the terminal identifier and the endpoint address.

19. An apparatus comprising:
a controller including circuitry configured to
receiving an instruction to detect and prioritize packet-based call transmissions from a radio access network,
detecting, in response to receiving the instruction, a packet-based call transmission through a default bearer of the radio access network based on a buffer state report from at least one of a terminal among a plurality of terminals and an access point of the radio access network, and
prioritizing a subsequent transmission of the packet-based call transmission.

20. The apparatus of claim 19, wherein the prioritizing includes
partitioning bandwidth of the default bearer to create a dedicated-bandwidth space within the default bearer, and
moving the subsequent transmission of the packet-based call transmission to the dedicated-bandwidth space.
